(19) United States
(12) Patent Application Publication
(10) Pub. No.: US 2014/0202186 A1
(43) Pub. Date: Jul. 24, 2014

(54) Zoned Evaporative Cooling Media for Air Intake House of Gas Turbine

(71) Applicant: Braden Manufacturing, LLC, Tulsa, OK (US)

(72) Inventors: Laquinnia Lawson, Jr., Tulsa, OK (US); Sanjay Mahapatra, Tulsa, OK (US)

(73) Assignee: Braden Manufacturing, LLC, Tulsa, OK (US)

(21) Appl. No.: 14/157,970

(22) Filed: Jan. 17, 2014

Related U.S. Application Data
(60) Provisional application No. 61/754,131, filed on Jan. 18, 2013.

(51) Int. Cl. F02C 7/04

(52) U.S. Cl. CPC F02C 7/04
USPC 62/89; 62/304; 415/116

(57) ABSTRACT

An evaporative cooling system for combustion gas turbine system has an array of cooling media including first and second cooling media types. The first cooling media type has a first maximum air velocity rating, and the second cooling media type has a second maximum air velocity rating that greater than the first maximum air velocity rating.

### FIELD OF THE INVENTION

The present invention generally relates to zoned evaporative cooling media for an air intake house of a gas turbine.

### BACKGROUND

Some intake air systems for combustion gas turbines include an inlet air cooling system for the purpose of increasing the air mass flow rate and power output. One type of inlet air cooling system is evaporative cooling technology. An evaporative cooling system is typically associated with an air inlet filter house of the gas turbine system. The evaporative cooling system includes evaporative media that is wetted by water to effect mass transport of water to the incoming air stream. This transport is provided by the loss of sensible heat from air resulting in air cooling. The cooled air is delivered to the gas turbine to increase air mass flow rate and power output.

### SUMMARY OF THE DISCLOSURE

In one aspect, an evaporative cooling system for an air intake system of a combustion gas turbine system generally comprises an array of evaporative cooling media including first and second cooling media types. The first cooling media type has a first maximum air velocity rating, and the second cooling media type has a second maximum air velocity rating greater than the first maximum air velocity rating.

In another aspect, an air intake system for a combustion gas turbine system including a gas turbine engine generally comprises an air inlet house defining an interior for receiving air from outside the gas turbine system and delivering air along an air flow path toward the gas turbine engine. At least one air filter is disposed in the air inlet house for filtering air flowing in the air inlet house toward the gas turbine system. An array of cooling media is in fluid communication with the air inlet house for cooling air flowing in the air intake system toward the gas turbine engine. The array of cooling media includes first and second cooling media types. The first cooling media type has a first maximum air velocity rating, and the second cooling media type has a second maximum air velocity rating greater than the first maximum air velocity rating.

In yet another aspect, a method of zoning an evaporative cooling system for a combustion gas turbine system including an air intake system defining an air flow path generally comprises determining a cross-sectional air velocity distribution at a cross-sectional area of the air flow path defined by the air intake system, wherein the air inlet velocity distribution includes first air velocities up to a first air velocity at first cross-sectional locations and a second air velocities greater than the first air velocity at second cross-sectional locations; and arranging first and second cooling media types in the air intake system as an array of cooling media based on the first and second cross-sectional locations of the respective first and second air velocities, wherein the first cooling media type is arranged in the array at cross-sectional locations generally corresponding to the first cross-sectional locations of the first air velocities, and the second cooling media type is positioned in the array at cross-sectional locations generally corresponding to the second cross-sectional locations of the second air velocities.

Other features will be in part apparent and in part pointed out hereinafter.

### BRIEF DESCRIPTION OF THE DRAWINGS

FIG. 1 is a perspective of a combustion gas turbine system;

FIG. 2 is a perspective of an air intake system of the gas turbine system of FIG. 1, the air intake system including the evaporative cooling system;

FIG. 3 is a schematic of the evaporative cooling system;

FIG. 4 is one embodiment of a block or pad of cooling media of the evaporative cooling system;

FIG. 5 is a simulated cross-sectional air velocity distribution for the air intake system computed using computational fluid dynamics (CFD) software;

FIG. 6 is an elevation of an inlet face of cooling media array based on the simulated cross-sectional air velocity distribution of FIG. 5;

FIG. 7 is a graph showing performance curves, including cooling efficiency, for TURBOdek™ cooling media having a thickness of 12 in (30.5 cm); and

FIG. 8 is a graph showing performance curves, including cooling efficiency, for REZNOR® cooling media having a thickness of 12 in (30.5 cm).

Corresponding reference characters indicate corresponding parts throughout the drawings.

### DETAILED DESCRIPTION OF THE DISCLOSURE

The present disclosure relates to an evaporative cooling system for a combustion gas turbine system. The evaporative cooling system is associated with an air intake system of the combustion gas turbine system. In particular, the evaporative cooling system is contained inside an inlet air filter house of the air intake system. The evaporative cooling system may be downstream or upstream of air filters in the air filter house, although typically the evaporative cooling system is downstream of the air filters and upstream of ducting (i.e., an inlet plenum) leading to the gas turbine. The evaporative cooling system includes a cooling media array comprising at least two different types of cooling media. A first cooling media type of the media array has a first maximum air velocity rating, while a second cooling media type of the media array has a second maximum air velocity rating that is greater than the first maximum air velocity rating. As defined herein, a “maximum air velocity rating” of a particular cooling media type is the maximum air velocity at the inlet or upstream face of the cooling media type for which the cooling media type has at least 90% cooling efficiency. As explained in more detail below, the cooling media types are selectively arranged or positioned in zones within the cooling media array based on the cross-sectional air velocity distribution at the upstream face of the cooling media array within the air intake system.

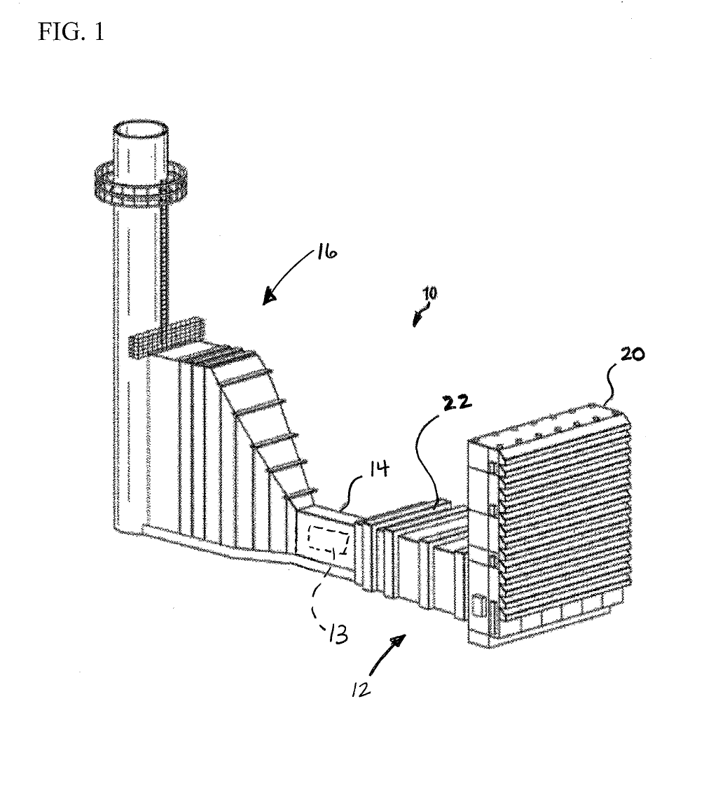

Referring to FIG. 1, one embodiment of a gas turbine system is generally indicated at reference numeral 10. As is generally known in the art, the gas turbine system 10 includes an air intake system, generally indicated at 12, upstream from a gas turbine engine 13 housed within a turbine housing 14. Although not shown, one of ordinary skill would understand that the gas turbine engine 13 includes a gas turbine compressor, which provides suction for pulling air through the air intake system 12 and into the gas turbine engine. Downstream of the gas turbine engine 13 is one embodiment of an exhaust gas system, generally indicated 16, the purpose and structure of which is known to those of ordinary skill and will not be described herein. In the illustrated embodiment, the air intake system 12 includes an air filter house 20 and an air intake duct or plenum 22 downstream of the air filter house and in fluid communication with the gas turbine 13. The air filter house 20 defines an interior for receiving air from outside the gas turbine system 10 and delivering air along an air flow path toward the gas turbine engine 13.

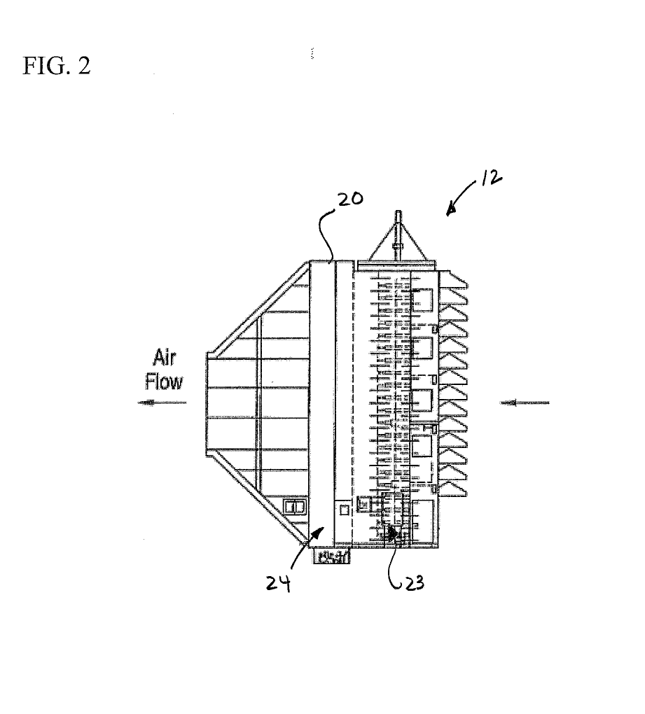

Referring to FIG. 2, an air filter system, generally indicated at 23, for ambient or atmospheric air flowing in the air filter house 20, and an evaporative cooling system, generally indicated at 24, are housed within the air filter house 20. The air filter system 23 includes at least one air filter (e.g., a plurality of air filters). In the illustrated embodiment, the evaporative cooling system 24 is located downstream from the air filter system. In other embodiments, the evaporative cooling system 24 may be located upstream from the air filters. The evaporative cooling system may be disposed outside (e.g., secured to) the air inlet filter house 20 and in fluid communication therewith.

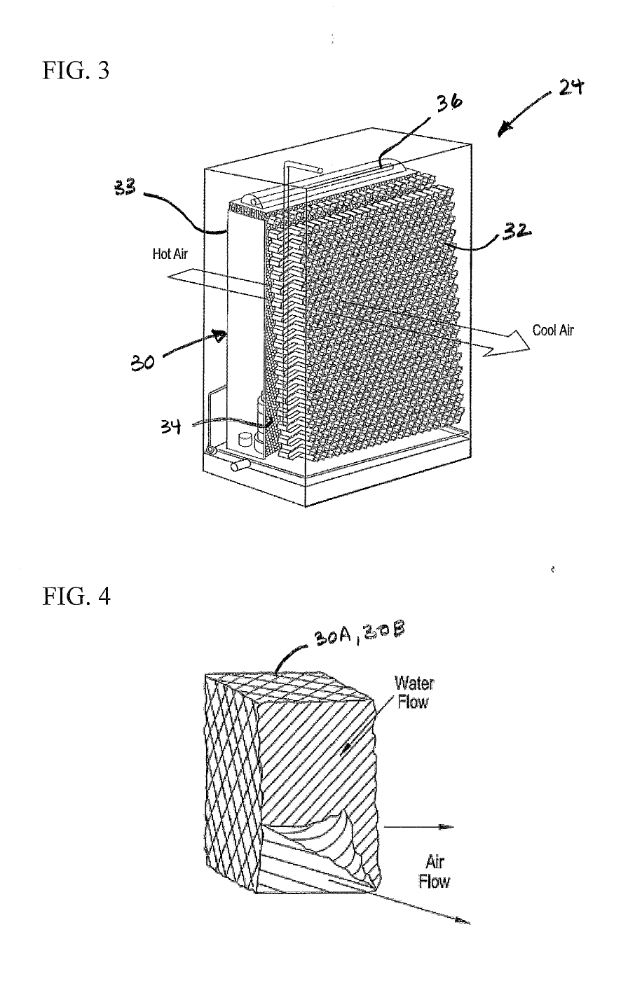

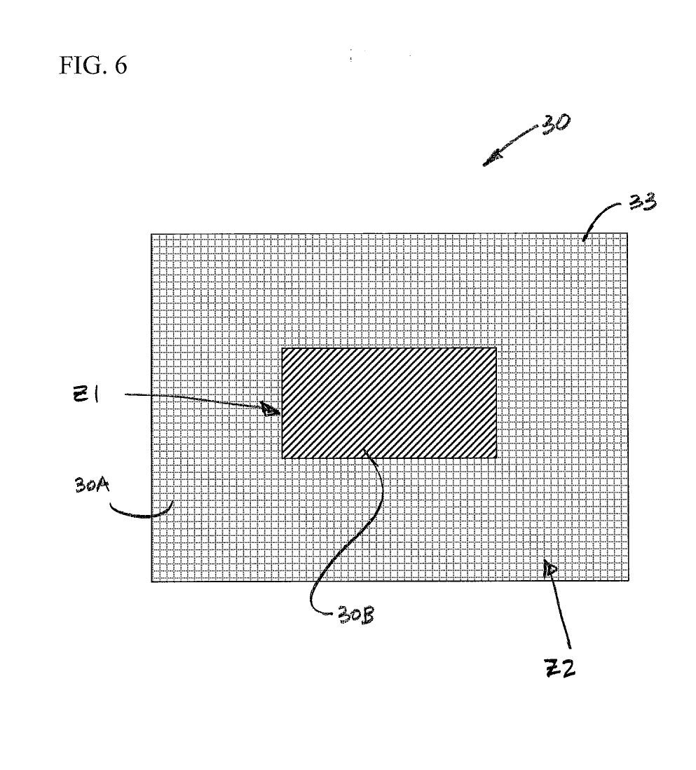

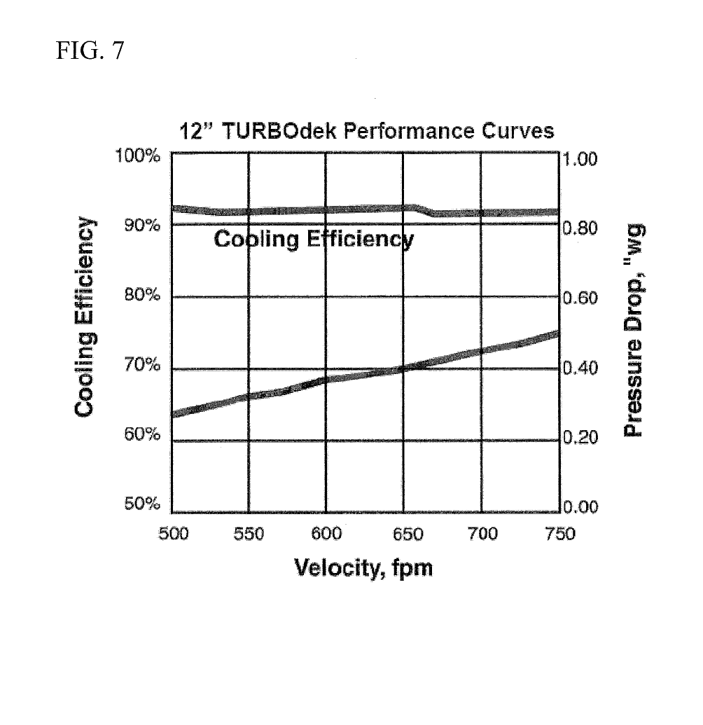

Referring to FIG. 3, the evaporative cooling system 24 includes a cooling media array, generally indicated at 30, and a mist (or drift) eliminator 32 downstream from the cooling media array. The mist eliminator 32 inhibits water entrained in the air flow from passing into the intake plenum 22 (FIG. 1). In other embodiments, the evaporative cooling system 24 may not include a mist eliminator without departing from the scope of the present invention. Mist eliminators are generally known to those having ordinary skill, and therefore, the details of the mist eliminator 32 is not provided herein. The cooling media array 30 is arranged as an air permeable wall within the air intake system 12 (e.g., within the air filter house 20) and includes an inlet or upstream face 33 (see also FIG. 6) through which intake air enters the media array, and an outlet or downstream face 34 through which intake air exits the media array. The evaporative cooling system 24 further includes a water distribution system 36 (FIG. 3) for delivering water to the cooling media array 30 such that the water travels by gravity downward to wet the media array. Different types and constructions of water distribution systems 36 are generally known in the art, and the evaporative cooling system 24 may include any suitable water distribution system. The process by which air is cooled as it passes through the media array 30 is generally known in the art and is not discussed in detail herein.

Referring to FIG. 6, the cooling media array 30 comprises at least two different types of cooling media: a first cooling media type 30A having a maximum air velocity rating of V1, and a second cooling media type 30B having a maximum air velocity rating of V2 that is greater than V1. As used herein, the first cooling media type is referred to as “low-velocity cooling media,” and the second cooling media type is referred to as “high-velocity cooling media,” with the understanding that the terms “low-velocity” and “high-velocity” are meant to be relative terms.

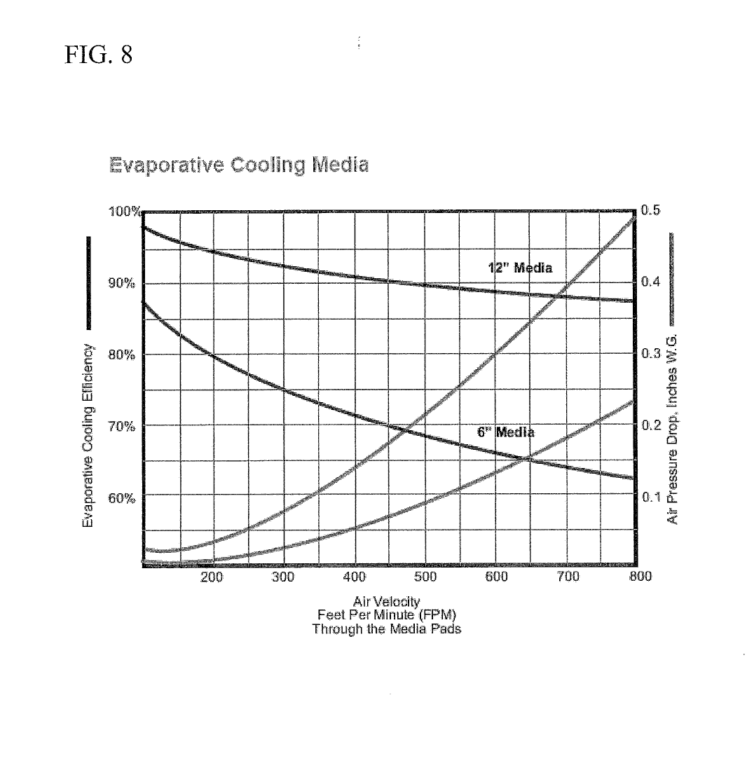

In one embodiment, the first and second cooling media types 30A, 30B may be different products having different constructions that allow for a difference in their respective maximum air velocity ratings, irrespective of the thicknesses of the cooling media types. In one embodiment, as a non-limiting example, a suitable product for the first cooling media type 30A (i.e., the low-velocity cooling media) may be REZNOR® cooling media available from Thomas & Betts Corporation (Memphis, Tenn.), and a suitable product for the second cooling media type 30B (i.e., the high-velocity cooling media) may be TURBOdek™ evaporative media available from Munters AB (Ft. Meyers, Fla.). As shown in FIG. 7 the TURBOdek™ evaporative media product having a thickness of 12 in (30.5 cm) is capable of at least 90% cooling efficiency at a maximum air velocity of greater than 500 fpm (i.e., has a maximum air velocity rating of greater than 500 fpm and up to 750 fpm). As shown in FIG. 8, the REZNOR® cooling media product having a thickness of 12 in (30.5 cm) is capable of at least 90% cooling efficiency at a maximum air velocity of about 500 fpm (i.e., has a maximum air velocity rating of about 500 fpm).

In another embodiment, the first and second cooling media types 30A, 30B may be the same product, but have different respective thicknesses. A cooling media product will have different cooling efficiencies depending on the thickness of the cooling media product. In general, the cooling efficiency of the cooling media product depends on its thickness, where increasing the thickness will generally increase the cooling efficiency. The graph of performance curves shown in FIG. 8 is an illustration of this phenomenon. As can be seen from the graph, the REZNOR® cooling media having a thickness of 12 in (30.5 cm) has a greater cooling efficiency than the same REZNOR® cooling media having a thickness of 6 in (15.3 cm). Accordingly, in one embodiment the first cooling media type 30A (i.e., the low-velocity cooling media) and the second cooling media type 30B (i.e., the high-velocity cooling media) may be of the same construction (i.e., the same product), but the first cooling media type having a thickness less than the second cooling medial type.

As shown in FIG. 4, the cooling media 30A, 30B may comprise a plurality of individual blocks or pads arranged to form the media array 30. In one example, the cooling media pads 30A, 30B are made from cellulose material and define a plurality of internal flutes to carry the water through the media. As set forth above, the constructions of the first and second cooling media pads may be different or the same.

As show in FIG. 6, the cooling media types 30A, 30B are positioned in predetermined “zones” within the cooling media array 30 based on a cross-sectional air velocity distribution at the upstream face 33 of the cooling media array. The term “cross-sectional” means generally transverse to the air flow path defined by the air intake system 12. In one example, the low-velocity media type 30A is positioned in the cooling media array 30 at cross-sectional locations or zone(s) where the air velocities are less than or equal to velocity V1, and the high-velocity media type 30B is positioned in the cooling media array at cross-sectional locations or zone(s) where the air velocities are greater than velocity V1. It is understood that the cooling media array 30 may include any number of different types of cooling media greater than or equal to two different types of media having different maximum air velocity ratings. For example, the cooling media array 30 may include a third cooling media type having a maximum air velocity rating between the velocity V1 and the velocity V2. The cooling media array 30 may have additional cooling media types with different ratings.

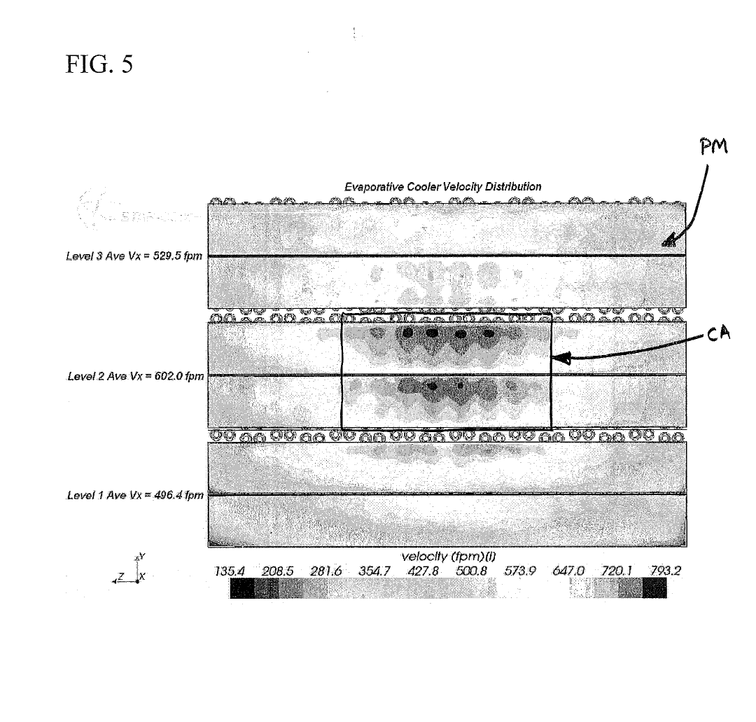

In a method of zoning an evaporative cooling system, the cross-sectional air velocity distribution of an air intake system may be determined by computer simulation. One example of a simulated cross-sectional air velocity distribution at the upstream face 33 of the cooling media array 30 is illustrated in FIG. 5. The simulated cross-sectional air velocity distribution was computed using computational fluid dynamics (CFD) software, such as STAR-CCM+® software available from CD-adapco, Melville, N.Y.). The cooling media types 30A, 30B shown in FIG. 6 are arranged in the air intake system as the cooling media array 30 based on the simulated cross-sectional air velocity distribution of FIG. 5. As can be generally seen from the simulated cross-sectional air velocity distribution in FIG. 5, air velocities increase toward the center of the upstream face 33 of the cooling media array 30, such that the lower air velocities are generally adjacent a perimeter margin PM of the cooling media array and the greater air velocities are generally adjacent a central area CA of the cooling media array. It is understood that air intake systems of other gas turbine systems may have other cross-sectional air velocity distributions. In general, the cross-sectional air velocity distribution of an air intake system is based, at least in part, on the suction profile of the gas turbine compressor and the design and geometry of the intake filter system, particularly the intake plenum. For example, some air intake systems of a particular gas turbine system may have an air inlet velocity distribution where the highest air velocities are adjacent a left or right side margin or a top or bottom margin, as opposed to being located at a central area.

Referring still to FIGS. 5 and 6, using the cross-sectional air velocity distribution of the particular air intake system, the cooling media array 30 can be designed and constructed using selected cooling media types having desired maximum air velocity ratings. Thus, the design and construction of the cooling media array 30 may also depend on the selected cooling media types. For example, the air inlet velocity distribution in FIG. 5 has a high concentration of air velocities greater than about 500 fpm at the central area CA, and most of the air velocities outside the central area, within the perimeter margin PM, are less than 500 fpm. Based on this information, the cooling media array 30 illustrated in FIG. 6 is be arranged so that a high-velocity cooling media 30B having a maximum air velocity rating greater than 500 fpm is positioned within a central zone Z1, and a low-velocity cooling media 30A having a maximum air velocity rating less than or equal to 500 fpm is positioned within an outer perimeter zone Z2, outside the central zone.

As will be understood, the design and construction of the cooling media array 30 may also depend on the commercial availability of cooling media types having different air velocity ratings. For example, in the illustrated air inlet velocity distribution, one may include a cooling media type having an air-velocity rating of up to 700 or 800 fpm in the central zone Z1 of the cooling media array 30, since this is the zone at which the air velocity is at its maximum. As set forth above, any number of different cooling media types may be used in the cooling media array 30. Moreover, although the perimeter shapes or footprints of the cooling media type zones Z1, Z2 are generally rectilinear (e.g., rectangular) in the embodiment illustrated in FIG. 6, the profiles of one or both of the cooling media type zones may be circular, elliptical, or other shapes without departing from the scope of the present invention. Moreover, the cooling media array 30 may have separate zones (i.e., non-contiguous zones) of the same cooling media type.

It is believed that the evaporative cooling system including zoned cooling media types 30A, 30B of different air-velocity ratings provides several advantages over evaporative cooling systems that have a single cooling media type. For example, the evaporative cooling system including zoned cooling media types 30A, 30B may have one or more of the following non-limiting advantages: a) uniform temperature distribution at the compressor intake; b) uniform air mixing; c) uniform velocity profile at the exit face of the evaporative cooling media; d) reduction in pressure drop due to lower shear forces between moving fluid flow layers of different densities, which also reduces the effect of fluid layering or lamination, e) reduction of under and over cooling of intake air; and f) reduction of water condensation.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. An evaporative cooling system for an air intake system of a combustion gas turbine system, the evaporative cooling system comprising:
an array of evaporative cooling media including first and second cooling media types, the first cooling media type having a first maximum air velocity rating, and the second cooling media type having a second maximum air velocity rating greater than the first maximum air velocity rating.

2. The evaporative cooling system set forth in claim 1, wherein the first and second cooling media types are selectively positioned in zones within the array based on a cross-sectional air velocity distribution at an inlet face of the cooling media array.

3. The evaporative cooling system set forth in claim 2, wherein the second cooling media type is positioned in a central zone of the array, and the first cooling media type is positioned in the perimeter zone of the array.

4. The evaporative cooling system set forth in claim 1, wherein the first and second cooling media types have equal thicknesses.

5. The evaporative cooling system set forth in claim 1, wherein the first and second cooling media types have different thicknesses.

6. An air intake system for a combustion gas turbine system including a gas turbine engine, the air inlet system comprising:
an air inlet house defining an interior for receiving air from outside the gas turbine system and delivering air along an air flow path toward the gas turbine engine;
at least one air filter disposed in the air inlet house for filtering air flowing in the air inlet house toward the gas turbine system;
an array of cooling media in fluid communication with the air inlet house for cooling air flowing in the air intake system toward the gas turbine engine, the array of cooling media including first and second cooling media types, the first cooling media type having a first maximum air velocity rating, and the second cooling media type having a second maximum air velocity rating greater than the first maximum air velocity rating.

7. The air intake system set forth in claim 6, wherein the array of cooling media is disposed in the air inlet house.

8. The air intake system set forth in claim 7, wherein the array of cooling media is downstream from the at least one air filter.

9. The air intake system set forth in claim 7, wherein the first and second cooling media types are selectively positioned in zones within the array based on a cross-sectional air velocity distribution at an inlet face of the array of cooling media.

10. The air intake system set forth in claim 9, wherein the second cooling media type is positioned in a central zone of the array, and the first cooling media type is positioned in the perimeter zone of the array.

11. The air intake system set forth in claim 6, wherein the first maximum air velocity rating is less than or equal to about 500 fpm, and the second maximum air velocity rating is greater than 500 fpm.

12. The air intake system set forth in claim 6, wherein the first and second cooling media types have equal thicknesses.

13. The air intake system set forth in claim 6, wherein the first and second cooling media types have different thicknesses.

14. A method of zoning an evaporative cooling system for a combustion gas turbine system including an air intake system defining an air flow path, the method comprising:
determining a cross-sectional air velocity distribution at a cross-sectional area of the air flow path defined by the air intake system, wherein the air inlet velocity distribution includes first air velocities up to a first air velocity at first cross-sectional locations and a second air velocities greater than the first air velocity at second cross-sectional locations;
arranging first and second cooling media types in the air intake system as an array of cooling media based on the first and second cross-sectional locations of the respective first and second air velocities, wherein the first cooling media type is arranged in the array at cross-sectional locations generally corresponding to the first cross-sectional locations of the first air velocities, and the second cooling media type is positioned in the array at cross-sectional locations generally corresponding to the second cross-sectional locations of the second air velocities.

15. The method set forth in claim 14, wherein said determining a cross-sectional air velocity distribution comprises simulating the cross-sectional air velocity distribution using computational fluid dynamics software.

16. The method set forth in claim 14, wherein the first and second cooling media types have equal thicknesses.

17. The method set forth in claim 14, wherein the first and second cooling media types have different thicknesses.
